(19) United States
(12) Patent Application Publication
(10) Pub. No.: US 2005/0229157 A1
(43) Pub. Date: Oct. 13, 2005

(54) Dynamic layout system and method for graphical user interfaces

(76) Inventor: Matthew Allen Johnson, Omaha, NE (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/822,244

(22) Filed: Apr. 8, 2004

(51) Int. Cl. G06F 9/44

(52) U.S. Cl. 717/114

(57) ABSTRACT

In a graphical user interface for a computer, a method of arranging objects to be displayed within windows forming the graphical user interface includes defining attributes of the objects and arranging the objects as a function of the defined attributes of the respective objects. The objects may be widgets and the defined attributes may define relationships among the objects as well as styles associated with the objects.

### BACKGROUND OF THE INVENTION

Most computers utilize a graphical user interface (GUI) which allows a user to input commands and data and receive displayed results from the computer. A GUI is part of an operating system (OS), such as Microsoft Windows, that controls the operation of the computer and determines how a user interacts with the computer. For example, one type of GUI is based on a visual metaphor which uses a display screen as a work surface called a “desktop,” where documents and other objects are presented to the user for selection. The user interacts with the computer by selecting objects on the desktop, for example, or choosing commands from menus presented on the desktop. An application program is a program that runs on the computer under control of the operating system, and the GUI determines how the user interacts with each application program.

Each object that is selected by the user typically opens a respective “window” on the display screen, with a window being an enclosed rectangular area on the display screen. Several windows may be opened at the same time. Displayed within each window is information associated with an underlying program, such as a word processor program for example. The window typically includes control boxes for manipulating the window, such as buttons to minimize or close the window along with checkboxes and scroll bars related to the underlying program. Moreover, each window typically includes a number of “containers” within the window, where each container may be viewed as sub-window within the window. Each container displays graphical elements or “widgets” that define how a user interacts with the GUI for an underlying program via that container. For example, in a word processing program a container may correspond to a group of features presented to the user on a toolbar at the top of the window. The terms “widgets” and “fields” will be used interchangeably herein, each referring to the graphical elements displayed within windows and containers of a GUI that define how a user interacts with the GUI and thereby the underlying program.

When a programmer is writing an application program, the programmer must develop the GUI for that program. To do this a programmer typically utilizes a program known as a “layout builder,” which is a program that allows the programmer to define the GUI for the program. Using the layout builder the programmer defines containers to be placed within given windows and selects options available within the layout builder for arranging the widgets within each container and the containers within the window. For example, the programmer may select widgets to be displayed within a container from a palette of available widgets and may then define how these widgets are to be arranged or laid out within the container. Some typical options for laying out widgets within a container include: 1) making each widget an equal size and arranging the widgets in a single row or column; 2) arranging the widgets in a row or column with a wrap option to place widgets that won't fit in a given row or column into an adjacent row or column; 3) a left to right or top to bottom flow layout; and 4) a grid layout that arranges widgets in an N×M grid within the container.

FIG. 1 shows an example of a customer order window 100 that is part of the GUI for an underlying application program. The customer order window 100 includes an address container 102 that includes the widgets or fields of name, phone, street address, city, state, and zip code displayed in an upper portion of the window. A billing address container 104 containing the same fields is contained in a lower portion of the window 100. In the example of FIG. 1, the fields in the shipping address container 102 are laid out in a row with wrap feature placing the “state” and “zip code” fields in a second row under the first row, and the same is true of the billing address field 104. Ideally the city, state, and zip code fields should be contained in the same line as this is the expected format of an address. Thus, a programmer may need to manually adjust the layout of the fields in the containers 102, 104 to obtain the desired arrangement.

In some situations, an application program may be customized for particular customers and part of this customization may include customizing certain windows and containers within those windows to modify the widgets or fields displayed based upon customer needs or preferences. For example, in the window 100 of FIG. 1 perhaps for a specific customer the phone field is unnecessary or unwanted by the customer. In this situation, a programmer must modify the window 100 by deleting the “phone” field in the shipping and billing address containers 102, 104. FIG. 2 illustrates a customer order window 200 that is the same as the window 100 of FIG. 1 except that a shipping address container 202 and a billing address container 204 each have their respective phone fields deleted. This deletion of the phone field leaves an unwanted space in each of the containers 202, 204 as shown. As a result, a programmer must again utilize the layout builder program to rearrange the fields in the containers to obtain the desired appearance.

The process of rearranging the widgets displayed in respective windows and containers of the GUI for a given application program is a time consuming and costly process. Moreover, each programmer may modify the windows and containers in different ways to obtain what that programmer believes to be the best aesthetic and functional layout. This may result in undesirable variation of the “look and feel” of the program from one customer to the next, when ideally the look and feel remains consistent among customers with only slight variations in the specific fields being displayed.

FIG. 3 illustrates another window 300 illustrating a third situation that commonly arises when programs are being customized for specific customers. In the window 300, a first programmer develops a shipping address container 302 for the GUI while a second programmer develops a billing address container 304. Due to personal preferences, the first programmer chooses a center flow layout for the fields in the container 302 while the second programmer chooses a tabular layout for the fields in the container 304. As a result, the window 300 displays the two containers 302, 304 in the disjointed manner shown in FIG. 3. Once again, to fix such problems a programmer must go through each window that is part of the GUI for the application program and make adjustments to the layouts of fields where necessary. When fixing the problems variation among the GUIs for different programs will arise again due to individual programmer preferences.

There is a need for laying out fields being displayed by a GUI in a manner that reduces the time necessary to customize the GUI and also maintains consistency among GUIs being customized for different customers.

### SUMMARY OF THE INVENTION

According to one aspect of the present invention, in a graphical user interface for a computer a method of arranging objects to be displayed within windows forming the graphical user interface. The method includes defining attributes of the objects and arranging the objects as a function of the defined attributes of the respective objects. The objects may be widgets and the defined attributes may define relationships among the objects as well as styles associated with the objects.

### BRIEF DESCRIPTION OF THE DRAWINGS

FIG. 1 is an example of a customer order window forming part of the graphical user interface of an underlying application program.

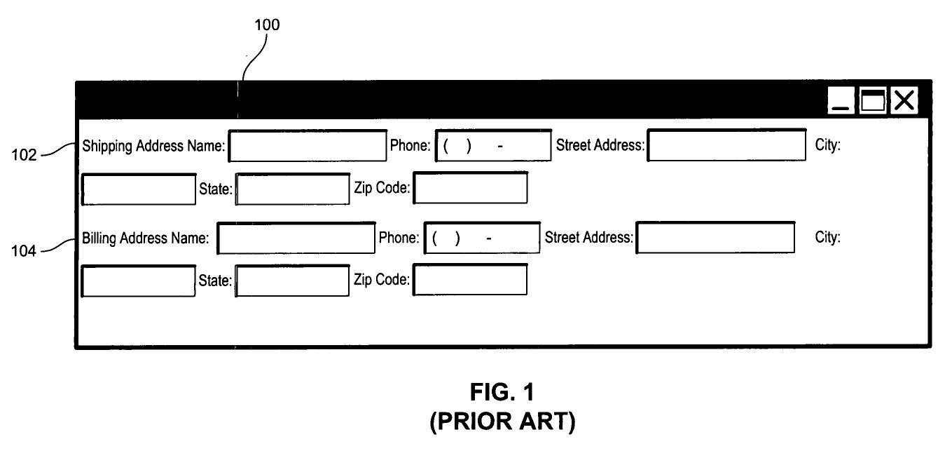

FIG. 2 illustrates unwanted spaces left behind in the customer order window of FIG. 1 when certain fields being displayed in the window are deleted.

FIG. 3 illustrates a window for a graphical user interface having two separate containers with two different layouts for fields within the containers.

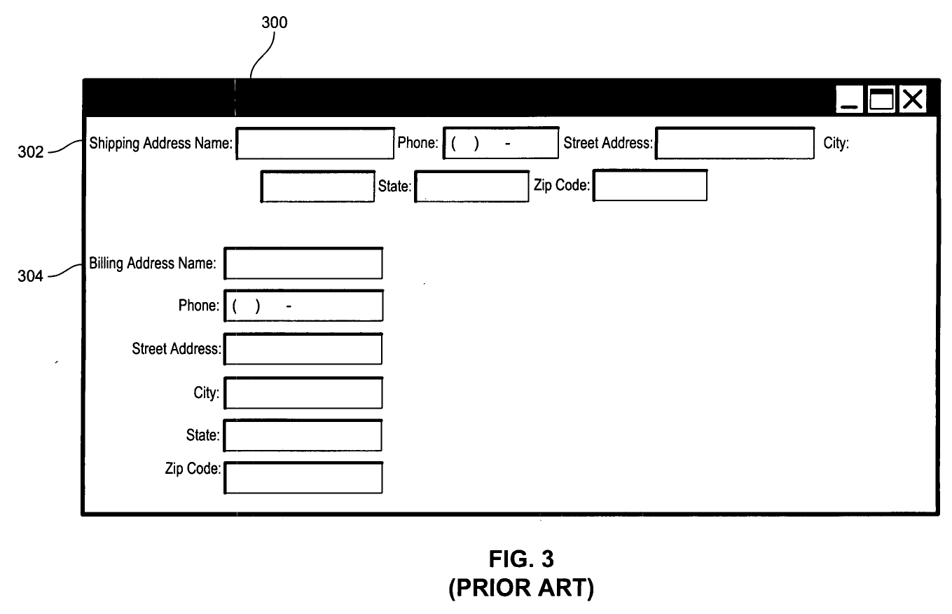

FIG. 4 is a functional block diagram of a computer system that executes a dynamic GUI layout builder program according to one embodiment of the present invention.

FIG. 5 is an example of a customer order window for a GUI having the fields contained in the window arranged by the layout builder program of FIG. 4.

FIG. 6 is an example of a customer order window for a GUI that is automatically generated by the layout builder program of FIG. 4 when certain fields of the customer order window of FIG. 5 are deleted.

### DETAILED DESCRIPTION OF PREFERRED EMBODIMENTS

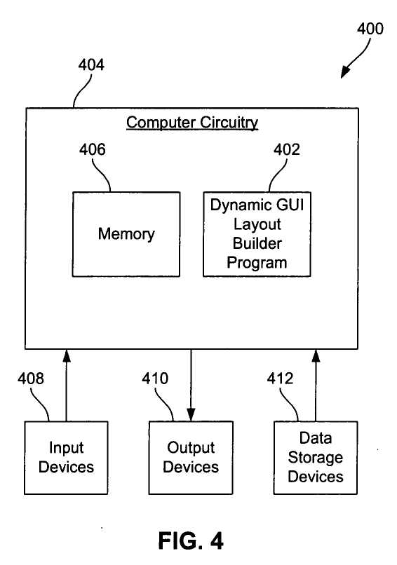

FIG. 4 is a functional block diagram of a computer system 400 that executes a dynamic GUI layout builder program 402 for dynamically laying out or arranging fields within windows of a GUI according to one embodiment of the present invention. More specifically, the layout builder program 402 allows a user to assign attributes to fields being placed within a window for the GUI that is being designed, and the program thereafter utilizes the assigned attributes to arrange the fields within the window as a function of these attributes, as will be explained in more detail below. In this way, the layout builder program 402 automatically arranges the fields to achieve an aesthetically pleasing and functional arrangement. Moreover, the builder program 402 enables consistency to be achieved among GUIs being customized for different customers since the same modification to a given window for two different customers will result in the same window in each of the GUIs for these customers. The builder program 402 also allows a user to associate styles with a container, window, or field and thereafter arranges the fields in the window or container according to the associated attributes and styles. These styles can be viewed as another attribute assigned to the fields or as an attribute assigned to a container or window, and enable the development of standards for GUIs by ensuring that windows of a predetermined type (e.g., customer order windows) will all have their corresponding fields arranged in the same manner as determined by the associated style.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail below to avoid unnecessarily obscuring the present invention.

The computer system 400 includes computer circuitry 404 which executes the layout builder program 402. The computer circuitry 404 includes circuitry for performing various computing functions, such as executing specific software like the layout builder program 402 to perform specific calculations or tasks. The computer circuitry 404 further includes memory 406 for storing programming instructions and data during execution of the layout builder program 402 and other programs (not shown). Typically, the computer circuitry 404 is coupled through address, data, and control buses to the memory 406 to provide for writing data to and reading data from the memory.

The computer system 400 also includes one or more input devices 408, such as a keyboard or a mouse, coupled to the computer circuitry 404 to allow an operator to interface with the computer system. Typically, the computer system 400 also includes one or more output devices 410 coupled to the computer circuitry 404, such as a printer and a monitor or video display. One or more data storage devices 412 are also typically coupled to the computer circuitry 404 to store data or retrieve data from external storage media (not shown). The layout builder program 402 would typically be stored on the data storage devices 412, with the program or portions thereof being transferred to the memory 406 during execution of the program, as will be appreciated by those skilled in the art. Examples of typical storage devices 412 include hard and floppy disks, tape cassettes, and optical disks storage devices such as compact disk read-only (CD-ROMs) and compact disk read-write (CD-RW) devices, as well as digital video disks (DVDs) devices.

In operation, a user designing a GUI for a particular application program executes the layout builder program 402 to design the various windows that collectively form the GUI. The layout builder program 402 allows the user to design each window by defining containers for the window and also defining the desired fields to be placed within each container. In addition, the layout builder program 402 also allows the user to assign attributes to each of the fields placed within a given container or window. The attributes assigned to each field define relationships among the fields, which the layout builder program 402 thereafter utilizes to arrange the fields within a container or window. These attributes may be assigned in various ways to establish the desired relationships among the fields, such as by assigning attributes to the fields to establish a hierarchy of the fields. For example, some fields may be designated as parent fields and some fields as child fields of those parent fields, and so on. Another example is to simply assign each field to one of a number of defined groups, such as an address group or financial data group.

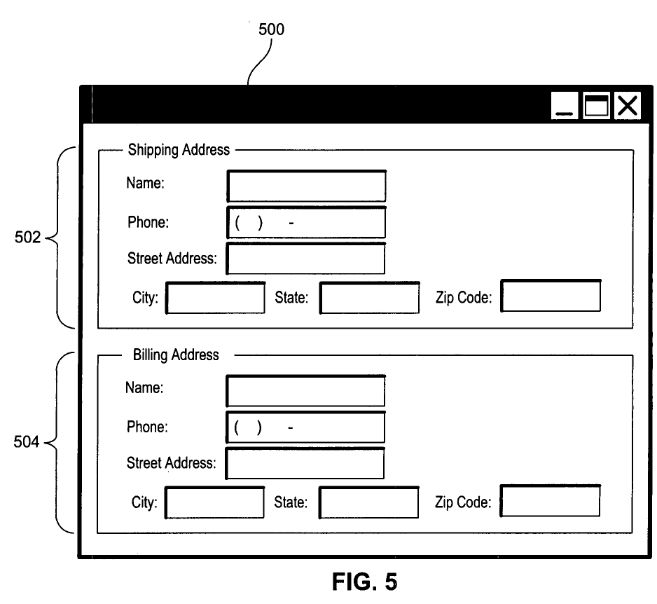

FIG. 5 is an example of a customer order window 500 for a GUI having a shipping address container 502 shown positioned in a top portion of the window and a billing address container 504 positioned in a bottom portion of the window. Each container 502, 504 includes a name, phone, street address, city, state, and zip code field. In this example, the attributes assigned to each of these fields may be done in a number of different ways. For example, in a first situation assume all these fields are simply contained within the window 500, meaning that the containers 502, 504 do not exist (i.e., the window includes a single container corresponding to the window). In this example, an attribute “shipping address” could be assigned to the name, phone, street address, city, state, and zip code fields positioned in the upper portion of the window 500 while an attribute “billing address” could be assigned to the same fields positioned in the bottom portion of the window. Furthermore, an additional attribute could be assigned to the city, state, and zip code fields since it is typically desirable to display these fields in a single line. Once these attributes are assigned to each of the fields, the layout builder program 402 arranges the fields within the window 500 based upon these attributes to generate the window 500 as shown in FIG. 5.

In the layout builder program 402, the specific attributes available to be assigned to the various fields and the particular arrangement of these fields using the assigned attributes may vary. In another example, a first set of the name, phone, street address, city, state, and the zip code fields may be placed in the container 502 and assigned the shipping address attribute. Similarly, a second set of the same fields may be placed in the container 504 and assigned the billing address attribute. Each of the fields within each container 502, 504 may then be assigned attributes to define a hierarchy among the fields, with the name field being at the top of the hierarchy and the city, state, and zip code fields being at the bottom of the hierarchy. The layout builder program 402 would then arrange the fields within each of the containers 502, 504 according to the assigned hierarchical attributes for the fields in each container, obtaining the layout for the window 500 shown in FIG. 5.

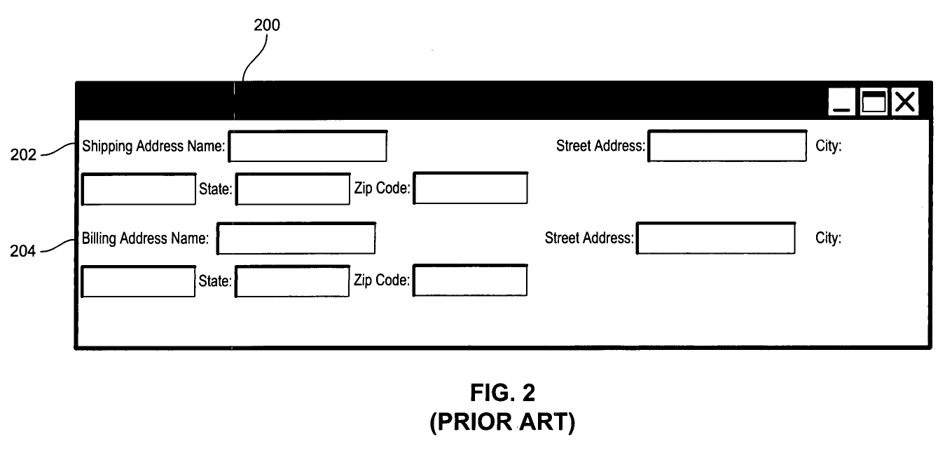

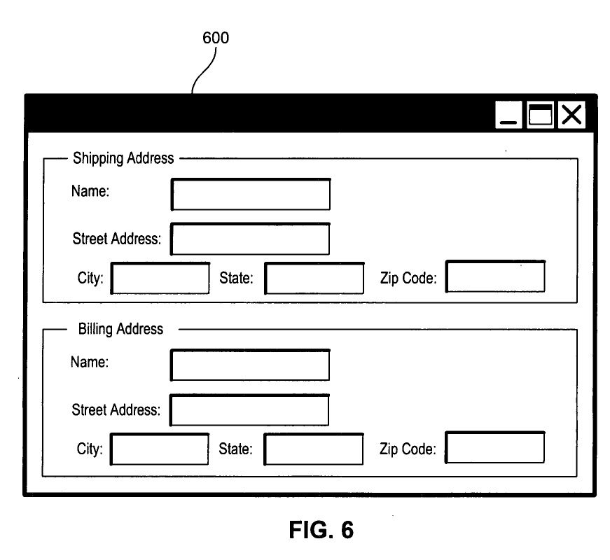

FIG. 6 is an example of a customer order window 600 for a GUI that is automatically generated by the layout builder program 402 of FIG. 4 when certain fields of the customer order window 500 of FIG. 5 are deleted. This example illustrates how the layout builder program 402 allows the GUI of an application program to be easily customized for specific customers. For example, assume that a particular customer does not want the phone field displayed in the window 500 of FIG. 5. In this situation, a user would delete the phone fields from the shipping address and billing address containers 502 and the layout builder program 402 would then automatically rearrange the new fields remaining in each container using the attributes assigned to these fields and thereby generating the window 600. The layout of FIG. 6 is aesthetically pleasing and functional and is in contrast to the layout of FIG. 2, which illustrates the unwanted spaces that occur with conventional layout builder programs when deleting a field and which needed to be manually corrected by a designer as previously discussed.

The layout builder program 402 operates in the same way when fields need to be added to a window, making customization of GUIs for specific customers much simpler and less time consuming. Moreover, the builder program 402 will generate windows having consistent appearances from one customer to the next since the program and not an individual designer is generating the customized windows.

The builder program 402 also allows styles to be assigned to a container, window, or field and thereafter arranges the fields in the window or container according to the associated attributes and styles. These styles can be viewed as another attribute assigned to the fields or as an attribute assigned to a container or window. By using predefined styles for certain types of GUI windows, such as the customer order windows utilized in the previous examples, the builder program 402 enables the development of standards for GUIs by ensuring that windows of a predetermined type (e.g., customer order windows) will all have their corresponding fields arranged in the same manner as determined by the associated style.

One skilled in the art will understand that even though various embodiments and advantages of the present invention have been set forth in the foregoing description, the above disclosure is illustrative only, and changes may be made in detail, and yet remain within the broad principles of the invention. Therefore, the present invention is to be limited only by the appended claims.

1. In a graphical user interface for a computer, a method of arranging objects to be displayed within windows forming the graphical user interface, the method comprising:
defining attributes of the objects; and
arranging the objects as a function of the defined attributes of the respective objects.

2. The method of claim 1 wherein defining attributes of the objects comprises assigning attributes to the objects to define hierarchical relationships among the objects.

3. The method of claim 2 wherein assigning attributes to the objects comprises assigning attributes to the objects responsive to user inputs.

4. The method of claim 1 wherein the objects include widgets.

5. The method of claim 4 wherein the widgets include buttons, dialog boxes, pop-up windows, pull-down menus, icons, scroll bars, resizable window edges, progress indicators, selection boxes, windows, tear-off menus, menu bars, toggle switches, and forms.

6. The method of claim 1 wherein one of the attributes assigned to each object comprises a style attribute and wherein the objects are arranged within the window according to the assigned style attributes.

7. The method of claim 1 wherein each window further comprises a plurality of containers and wherein the method comprises defining attributes of objects within each container and arranging the objects within the container as a function of the defined attributes.

8. The method of claim 7 further comprising defining a style attribute for each container and arranging the objects within the container as a function of this defined style attribute.

9. The method of claim 7 further comprising defining attributes of each container to be displayed within a given window and arranging the containers within the window as a function of these attributes.

10. The method of claim 1 further comprising:
after arranging the objects, deleting selected ones of the objects in the window; and
after deleting the selected ones of the objects, once again arranging the objects as a function of the defined attributes of the remaining objects.

11. The method of claim 1 wherein defining attributes of the objects comprises identifying relationships among objects defining attributes of the objects responsive to user inputs.

12. In a graphical user interface for a computer, a method of arranging widgets being displayed within windows forming the graphical user interface, the method comprising:
selecting widgets to be placed within respective windows;
assigning characteristics to the selected widgets that establish relationships among the widgets; and
arranging the widgets within each window as a function of the assigned characteristics.

13. The method of claim 12 wherein the widgets include buttons, dialog boxes, pop-up windows, pull-down menus, icons, scroll bars, resizable window edges, progress indicators, selection boxes, windows, tear-off menus, menu bars, toggle switches, and forms.

14. The method of claim 12 further comprising wherein assigning characteristics of the selected widgets comprises assigning characteristics to the selected widgets to define hierarchical relationships among the widgets.

15. The method of claim 12 wherein one of the characteristics assigned to each widget comprises a style characteristic and wherein the widgets are arranged within the window according to the assigned style characteristics.

16. The method of claim 12 wherein each window further comprises a plurality of containers and wherein the method comprises assigning characteristics of selected widgets within each container and arranging the widgets within each container as a function of the defined characteristics.

17. The method of claim 16 further comprising assigning characteristics of each container to be displayed within a given window and arranging the containers within the window as a function of these characteristics.

18. A computer-readable medium having stored thereon a layout builder program for arranging objects to be displayed within widows of a graphical user interface by performing the operations of:
defining attributes of the objects; and
arranging the objects as a function of the defined attributes of the respective objects.

19. The computer-readable medium of claim 18 wherein the computer-readable medium comprises an optical disk.

20. The computer-readable medium of claim 19 wherein the optical disk comprises a compact disk.

21. The computer-readable medium of claim 18 wherein defining attributes of the objects comprises assigning attributes to the selected objects to define hierarchical relationships among the objects.

22. The computer-readable medium of claim 18 wherein the selected objects include widgets.

23. The computer-readable medium of claim 22 wherein the widgets include buttons, dialog boxes, pop-up windows, pull-down menus, icons, scroll bars, resizable window edges, progress indicators, selection boxes, windows, tear-off menus, menu bars, toggle switches, and forms.

24. The computer-readable medium of claim 18 wherein each window further comprises a plurality of containers and wherein the method comprises defining attributes of selected objects within each container and arranging the objects within each container as a function of the defined attributes.

25. The computer-readable medium of claim 24 further comprising defining attributes of each container to be displayed within a given window and arranging the containers within the window as a function of these attributes.

26. The computer-readable medium of claim 18 wherein one of the attributes assigned to each object comprises a style attribute and wherein the objects are arranged within the window according to the assigned style attributes.

27. A computer system, comprising:
an input device;
an output device; and
computer circuitry coupled to the input and output devices and operable to execute a layout builder program, the layout builder program being operable to define attributes of objects to be displayed within a window of a graphical user interface and further operable to arrange the objects within the window as a function of the defined attributes of the respective objects

28. The computer system of claim 27 further comprising data storage devices coupled to the computer circuitry.

29. The computer system of claim 27 wherein the layout builder program is operable in response to user inputs from the input device to assign attributes to the objects that define hierarchical relationships among the objects.

30. The computer system of claim 27 wherein the layout builder program is operable to assign a style attribute to each object and is further operable to arrange the objects within the window according to the assigned style attributes.

31. The computer system of claim 27 wherein the layout builder program is further operable in response to user inputs from the input device to delete selected objects in the window and to thereafter arrange the remaining objects as a function of the defined attributes of the remaining objects.
